(19) United States
(12) Patent Application Publication
(10) Pub. No.: US 2025/0246097 A1
(43) Pub. Date: Jul. 31, 2025

(54) JOINT REDUCTION SIMULATION TRAINING DEVICES AND METHODS

(71) Applicant: LUNA INNOVATIONS INCORPORATED, Roanoke, VA (US)

(72) Inventors: Matthew PATTERSON, Charlottesville, VA (US); Kelley VIRGILIO, Charlottesville, VA (US); David REMER, Charlottesville, VA (US); Jonathon JANSEN, Charlottesville, VA (US); Brad DAY, Charlottesville, VA (US); Christopher TISON, Charlottesville, VA (US)

(21) Appl. No.: 18/874,496

(22) PCT Filed: Feb. 17, 2022
(86) PCT No.: PCT/US2022/016716

§ 371 Date: Dec. 12, 2024

Related U.S. Application Data
(60) Provisional application No. 63/177,478, filed on Apr. 21, 2021.

(51) Int. Cl. G09B 23/32; G01D 5/251

(52) U.S. Cl. CPC G09B 23/32; G01D 5/2515

(57) ABSTRACT

Joint reduction simulation training devices include a proximal bone component, and a distal bone component adjacently positioned relative to the proximal bone component. The proximal bone component is provided with a dislocation guide operatively cooperating with an opposed terminal end of the distal simulated bone component to provide a simulated joint between the proximal and distal bone components. The dislocation guide includes a dislocation and reduction sockets establishing dislocated and reduction positions of the distal simulated bone component relative to the proximal bone component when the terminal end of the distal simulated bone component is physically positioned within either the dislocation socket or the reduction socket. A transition surface joins the dislocation and reduction sockets such that the terminal end of the distal simulated bone component is in traversing engagement with the transition surface when the terminal end of the distal simulated bone component is moved from the dislocation socket and into the reduction socket during a reduction training exercise.

### CROSS-REFERENCE TO RELATED APPLICATION

This application is based on and claims priority benefits from U.S. Provisional Application Ser. No. 63/177,478 filed on Apr. 21, 2021 (Atty. Dkt. 4271-0633), the entire contents of which are expressly incorporated hereinto by reference.

### GOVERNMENT RIGHTS

This invention was made with Government support by the Defense Health Agency (DHA) under contract numbers W81XWH-18-C-0307 and W81XWH-19-C-0052. The Government has certain rights to the invention.

### FIELD

The embodiments disclosed herein related generally to medical simulation training devices and methods. In preferred forms, the embodiments disclosed herein related to training devices which possess biofidelic motion and anatomical landmarks for simulated joint reduction training and to methods of using the same during joint reduction simulation training.

### BACKGROUND

Medical simulation bridges the gap between classroom presentation and clinical training with human patients. The primary goal of simulation-based training is to replace and amplify real experiences with guided ones that evoke or replicate substantial aspects of the real world in a fully interactive fashion. Although simulation training can never replace clinical patient training, it can enable earlier, more repetitive, and more cost-effective hands-on training in proper technique, thereby accelerating development of the necessary cognitive and psychomotor skills. One area in which training platforms are particularly lacking is joint dislocation. Specifically, for both military and civilian doctors and related medical professionals (e.g., nurses, paramedics, athletic trainers, physical therapists, and the like), the first time that a joint reduction is performed is typically on an actual patient. A biofidelic joint reduction training platform could therefore be used to teach medical personnel proper recognition of dislocation and the procedure necessary to reduce the joint. Unfortunately, no such training platform is known to exist.

Currently, joint reductions are taught through explanation and demonstration on non-injured patients due to a lack of training platforms designed with biofidelic reduction forces and techniques. Thus, there exists a need for biofidelic, low-cost, joint reduction task trainers so that medical personnel have a repeatable, no-risk method for practicing joint reduction. It is towards providing such a need that the embodiments disclosed herein are directed

### SUMMARY

To address the critical need for joint reduction simulation training as discussed above, the embodiments disclosed herein have been developed which provide realistic anatomy and reduction forces. Currently available embodiments provide training devices specifically related to shoulder, elbow, and finger joints, but the design concepts as disclosed herein can be extended to any joint in which medical personnel may need to perform a reduction.

By way of example, the internal structure of the shoulder training device in accordance with an embodiment of this invention includes 3D printed or molded representations of the bones surrounding the joint. A 3D printed or molded dislocation guide provides two equilibrium joint positions (reduced and dislocated) and a transition zone that may be adjusted e.g., in terms of length, slope and the like, to alter the type of dislocation, difficulty of reduction, or the procedure used to reduce the joint.

In accordance with some embodiments, the training device may be equipped with the ability to interchange different dislocation guides that represent different dislocations or reduction procedures. Mechanical sensors (e.g., a cooperative reed switch and magnet arrangement) may additionally be incorporated in operative association with the training device so as to detect when the representative bone returns to the reduced position or to characterize the reduction dynamics for performance metric tracking (e.g., via an accelerometer, gyroscope and/or magnetometer).

Muscles, ligaments, and tendons may be represented by suitable tension elements which connect the representative bone that is moved during the reduction to integration sites on the representative bone structure or joint. The number of tension elements are reduced based on bio-informed computational models that provide guidance on the minimum number of tension elements required to maintain biofidelic forces during dislocation and reduction of the joint. The forces for the tension elements are tuned to maintain the joint in equilibrium in the reduced and dislocated positions and are prescribed so that both the magnitude and direction of the force vectors are biofidelic. The preferred tension element is a spring, but elastic bands or similar elements that apply tension during elongation may be used to secure the representative bone in place. The spring or like tension element may be attached from the representative bone through a cut channel in the representative bone and/or dislocation guide. The internal components of the trainer may optionally be enclosed by a soft tissue covering made of silicone or synthetic fabrics in order to simulate a patient's complete limb or appendage structure.

The joint reduction training devices as disclosed herein include embodiments simulating major joints including the shoulder joints, elbow joints, and phalangeal joints in the finger that will enable no-risk, repetitive joint reduction training. The training devices include simplified, anatomical features to represent the bones (e.g., the shoulder reduction trainer includes the humerus, scapula and glenohumeral joint) and tension elements (e.g., springs and/or elastic bands) to represent physiologic tensile elements (e.g., muscles, tendons and ligaments). A dislocation guide is incorporated in the training devices to provide a motion pathway from the dislocated to reduced position. The internal components may optionally be enclosed in a soft tissue covering. Further, the joint reduction training devices as disclosed herein may include position, motion, and other sensors (reed switch, accelerometer, gyroscope, and magnetometer) to quantify the reduction dynamics to quantify performance metrics and identify successful completion of a joint reduction.

The joint reduction training devices in accordance with the embodiments disclosed herein may usefully be employed to train medical personnel in the techniques needed to reduce major joints properly. Thus, the training devices may be employed medical education coordinators for athletic training, orthopedics, emergency medicine, or medical simulation centers. The sensors could be employed to quantify proper reduction techniques, as completed by experts, to provide feedback to users of the joint reduction training device.

Specific embodiments of the joint reduction simulation training device preferably include a proximal bone component, and a distal bone component adjacently positioned relative to the proximal bone component. The proximal bone component is provided with a dislocation guide operatively cooperating with an opposed terminal end of the distal simulated bone component to provide a simulated joint between the proximal and distal bone components. In certain embodiments, the dislocation guide includes a dislocation socket establishing a dislocated position of the distal simulated bone component relative to the proximal bone component when the terminal end of the distal simulated bone component is physically positioned within the dislocation socket and a reduction socket establishing a reduced position of the distal simulated bone component relative to the proximal bone component when the terminal end of the distal simulated bone component is physically positioned within the reduction socket. A transition surface joining the dislocation and reduction sockets is provided such that the terminal end of the distal simulated bone component is in traversing engagement with the transition surface when the terminal end of the distal simulated bone component is moved from the dislocation socket and into the reduction socket during a reduction training exercise.

The dislocation and reduction sockets may be oppositely aligned with one another (i.e., in the same plane at about 180° oppostion). Alternatively, the dislocation and reduction sockets may be angularly oriented relative to one another at an angle a that is greater than about 45°, for example, from greater than about 90° to less than 180°, e.g., about 135° +/−10°. Different angular orientations of the dislocation and reduction sockets will therefore provide a range of reduction difficulty for the person being trained.

At least one tension element (e.g., a tension spring or an elastic band) is provided so as to exert a biofidelic tension force between the proximal and distal bone components.

The joint training device can be embodied to simulate a number of anatomical joints, for example, shoulder, elbow and phalange joints.

Position and dynamic sensor systems may be operatively associated with the training device for sensing a position of the terminal end of the distal bone component within the reduction socket and/or to sense dynamic forces associated with the distal simulated bone component encountered during the reduction training exercise.

By way of example, a position sensor system may include a normally open magnetically operable reed switch operatively associated with the reduction socket of the dislocation guide and at least one permanent magnet which defines a correct reduction of the terminal end of the simulated bone component in the reduction socket provided at the terminal end of the distal simulated bone component. An annunciator providing visual and/or aural annunciations may therefore receive an annunciation signal from the reed switch in response to the reed switch being operated by at least one permanent magnet being in operative position relative thereto.

A dynamic force sensor system may include a dynamic force sensor array having at least one dynamic force sensor selected from the group consisting of accelerometers, magnetometers, gyroscopes and force/strain sensors operatively connected to the distal simulated bone component to provide quantitative data associated with joint reduction dynamics of the training device. By way of example, an inertial measurement unit (IMU) may be integrated onto the distal simulated bone component which includes a 3-axis accelerometer, 3-axis gyroscope and 3-axis magnetometer to generate respective inertial data signals in response to movement of the distal simulated bone component. A wireless transmitter module may thus be operatively connected to the IMU to receive the inertial data signals generated by the IMU and to transmit the inertial data signals wirelessly to a receiving computing device.

These and other aspects of the present invention will become more clear after careful consideration is given to the following detailed description of a presently preferred exemplary embodiment thereof.

### BRIEF DESCRIPTION OF THE DRAWINGS

Reference will be made to the accompanying drawing Figures, wherein:

FIG. 1 is a perspective view of a shoulder joint dislocation training device in accordance with an embodiment of the invention described herein;

FIGS. 2 and 3 are enlarged perspective views of the simulated shoulder joint structures associated with the shoulder joint dislocation training device shown in FIG. 1 in reduced and dislocated states, respectively;

FIGS. 4 and 5 are front and rear exploded front perspective view of the simulated shoulder joint structures shown in FIGS. 2 and 3;

FIGS. 6A and 6B are cross-sectional elevational views of different embodiments of the dislocation guide that may be employed in the training device of FIG. 1 having different angular orientation between the dislocated and reduced position sockets to simulate different patient positions and difficulties for the reduction training exercise;

FIG. 7 is an alternative embodiment of a shoulder joint dislocation training device in accordance with the invention described herein;

FIGS. 8A and 8B depict an embodiment of the dislocation guide that may be employed in the shoulder joint training device shown in FIG. 7, where FIG. 8A is a top plan view of the dislocation guide and FIG. 8B is a cross-sectional elevational view thereof as taken along line 8B-8B in FIG. 8A, respectively;

FIGS. 9A-9C show an embodiment of an elbow joint dislocation training device in accordance with the invention described herein, where FIGS. 9A and 9B are top and bottom perspective views, respectively, and FIG. 9C is a cross-sectional elevational view as taken along lines 9C-9C in FIG. 9A;

FIGS. 10A and 10B are perspective views of the elbow joint dislocation training device depicted n FIGS. 9A-9C in dislocated and reduced states, respectively; and

FIGS. 11A and 11B show an embodiment of a finger joint dislocation training device in accordance with the invention described herein in dislocated and reduced states, respectively.

### DETAILED DESCRIPTION

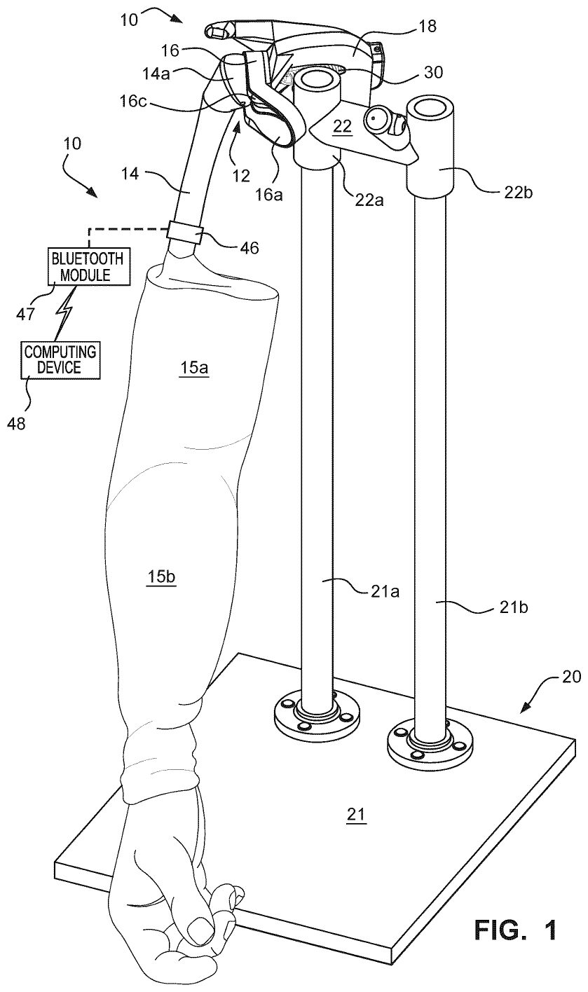

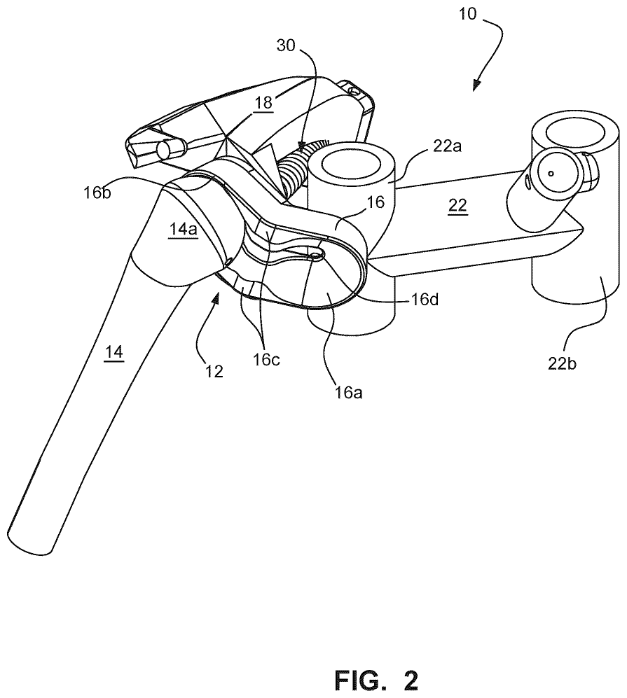

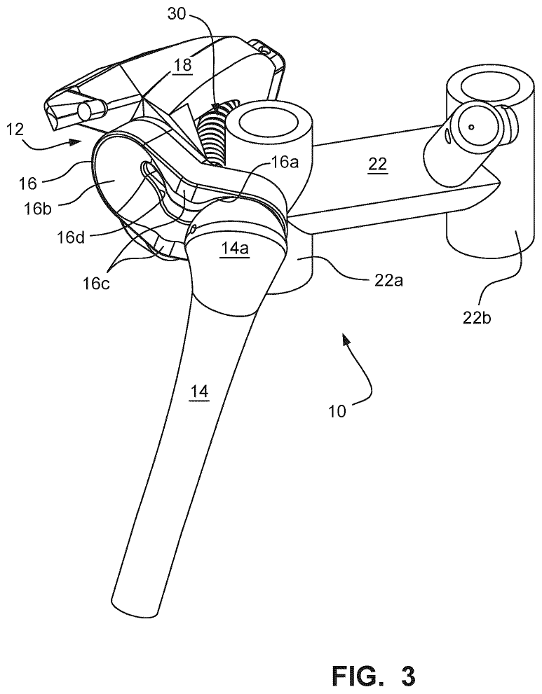

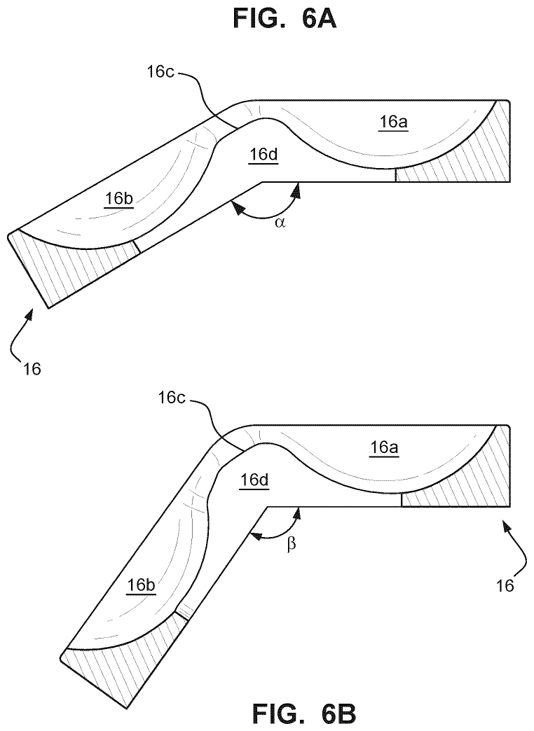

An embodiment of shoulder joint dislocation training device 10 in accordance with an embodiment of the invention is shown in FIGS. 1-5. As shown specifically in FIG. 1, the shoulder joint training device 10 includes a simulated shoulder joint 12 formed by the humeral head 14a of a simulated humerus bone 14 positioned distally of but received within a socket 16b associated with a proximally positioned dislocation guide 16 (see FIG. 6A). The socket 16b of the dislocation guide 16 establishes the reduction position of the humeral head 14a, while the socket 16a establishes the dislocated position of the humeral head 14a. A transition surface 16c joins the dislocated and reduced position sockets 16a, 16b, respectively. The dislocation guide 16 may itself be immovably fixed to a simulated scapula bone 18 which provides a base structure for the shoulder joint 12.

The simulated humerus bone 14 may be provided with anatomically correct external features to enhance the joint reduction training experience. For example, the simulated humerus bone 14 may be covered with a smooth skinned foam material to simulate the soft tissue and skin of upper and lower arms 15a, 15b, respectively, of a patient. Although not shown, the training device 10 may be incorporated into a simulated upper torso of a patient with a foam core and silicone skin covering for the chest, arm, hand, or any other appendages.

The training device 10 may also be used in virtually any position to simulate and provide dislocation training for patients in a variety of presenting positions. For example, the training device 10 is depicted in FIG. 1 as being associated with an optional stand structure 20 having a stand plate 21 and a pair of upright support rods 21a, 21b. A height adjustable support member 22 having tubular supports 22a, 22b sleeved over the support rods 21a, 21b, respectively, may thus be connected to the simulated scapula 18 to thereby provide structural support for the training device 10. As shown in FIG. 1, therefore, the shoulder joint dislocation training device 10 simulates a patient being in a sitting or upright position. However, the training device 10 may be removed from the stand and used to simulate a patient in a supine position.

Suitable tension elements are provided so as to operatively interconnect the humeral head 14a and the dislocation guide so as to provide biofidelic forces during the reduction training exercise using the training device 10. In this regard, the tension elements may include elastic bands, elastic cords, springs and the like. In the embodiment depicted in FIGS. 1-5, the tension element is embodied in a tension spring 30 extending between and fixed to the humeral head 14a and the simulated scapula 18. An elongate channel 16d is formed in the dislocation guide 16 extending between the dislocated and reduced position sockets 16a, 16b, respectively, so as to allow the tension spring 30 to move therewithin when the humeral head 14a is moved from the dislocation socket 16a to the reduction socket 16b during a reduction training exercise.

The dislocation guide 16 that may be employed in the shoulder joint training device 10 of FIG. 1 is shown in greater detail in accompanying FIGS. 6A and 6B. As discussed above, the dislocation guide 16 defines adjacent dislocated and reduced position sockets 16a, 16b joined by a transition surface 16c. As is shown in greater detail in FIG. 6A, adjacent dislocated and reduced position sockets 16a, 16b are angularly displaced relative to one another by an angle α which is greater than about 45°, for example from greater than about 90° to less than 180°, e.g., about 135° +/−10°. The angular displacement of the adjacent dislocated and reduced position sockets 16a, 16b will therefore determine the difficulty in the reduction exercise when moving the simulated humeral head from the disclosed position established by the socket 16a to the reduced position established by the socket 16b. By way of example, as is shown in FIG. 6B the angular displacement between the dislocated and reduced position sockets 16a, 16b is at an angle β which is less than the angle α shown in FIG. 6A. The lesser angular displacement of angle β as compared to the angular displacement a therefore requires a greater force to move the simulated humeral head 14a over the transition surface 16c and thereby presents the trainee with a more difficult reduction training challenge.

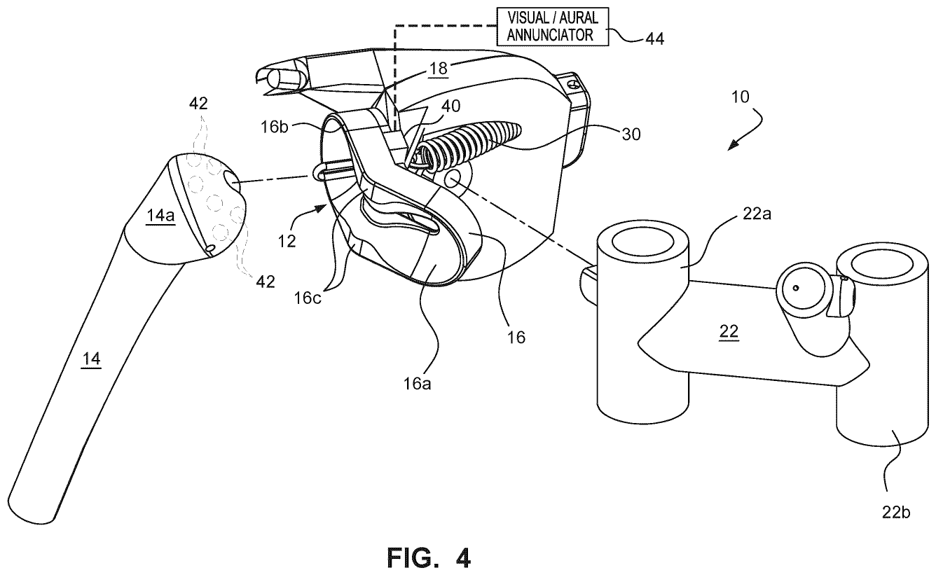

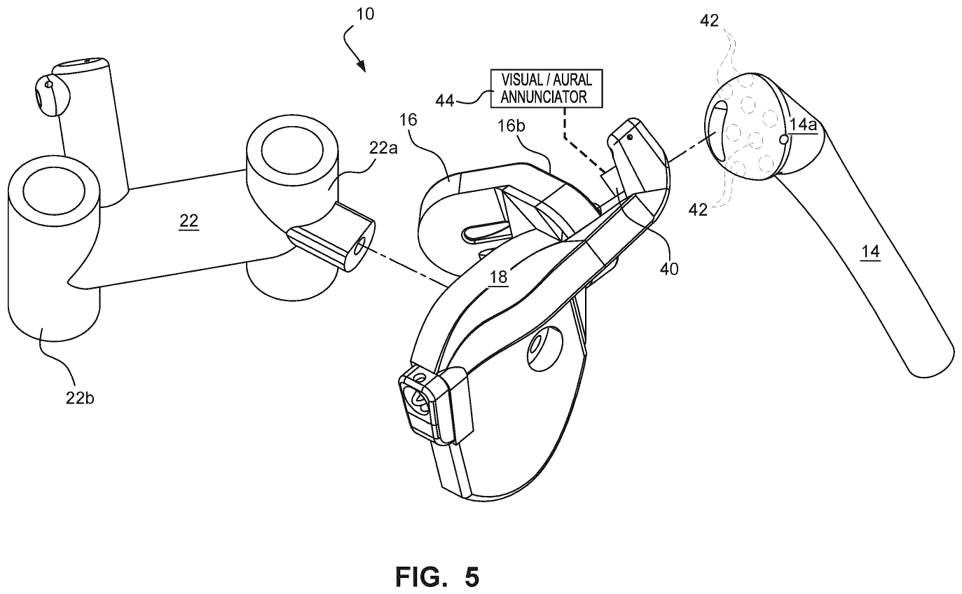

Negative training is a process whereby the lack of biofidelity results in muscle-memory and training that causes more harm than good when transitioned to a patient. To reduce the potential for negative training, the embodiment of the joint reduction training device 10 may also include a location sensor system to detect proper reduction of the joint or to characterize the reduction dynamics. To detect reduction, a sensor switch, for example, a reed switch (schematically shown by reference number 40 in FIGS. 4 and 5), may be embedded into the reduction socket 16b of the dislocation guide 16. The normally open sensor switch 40 will thus close when a force (e.g., magnetic field) of sufficient strength moves within the sensing range of the switch 40. The force is applied when the representative simulated bone component, e.g., the simulated humeral head 14a is in a properly reduced position within the reduction socket 16b of the dislocation guide. For such purpose, permanent magnets (a representative few of which are identified by reference numeral 42 in FIGS. 4 and 5) may be integrated into the simulated humeral head 14a such that when the shoulder joint 12 is reduced the magnetic field from the humeral head 14a is detected by the sensor (reed) switch 40 and a signal is sent to the user (e.g., via visual or audio annunciator 44) that the joint has been reduced.

In addition to location sensors, the joint reduction training device 10 may also include dynamic sensors to measure joint reduction dynamics, such as accelerometers, magnetometers, gyroscopes, or force/strain sensors. A representative dynamic sensor array 46 that may include one or more of such dynamic sensors is shown schematically in FIG. 1. Quantitative measurements of joint reduction dynamics can be used for tracking performance metrics and assessing the skills of the users. An advanced sensor array 46 may therefore be integrated into the representative bone structure that is manipulated during the reduction technique (e.g., the simulated humerus bone component 14 as shown in FIG. 1 for shoulder reductions). By way of example, the sensor array 46 employed in the shoulder joint training device 10 shown in FIG. 1 may include an inertial measurement unit (IMU) integrated onto the simulated humeral bone shaft that includes a 3-axis accelerometer, 3-axis gyroscope, and 3-axis magnetometer onto one breakout board, allowing the IMU to detect orientation, velocity, and acceleration in 3D space. The data from the IMU of the sensor array 46 can be transmitted wirelessly though an operatively associated wireless transmitter module 47 (e.g., an HC-06 Bluetooth module) and then accessed via a compatible computing device 48, e.g., a hand-held tablet, smart phone or personal computer. This data can then be used to analyze the reduction dynamics from a student practicing a reduction compared to an expert performing a reduction for the purpose of technique training.

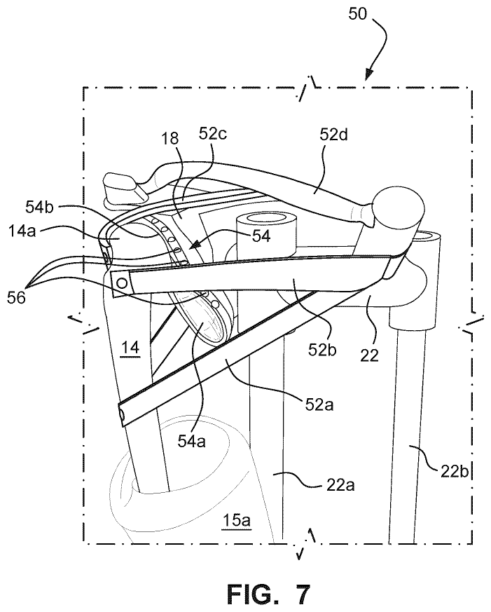

An alternative embodiment of a shoulder joint training device 50 is shown in FIG. 7. As can be seen, the training device 50 is similar to the training device 10 described above in that it may be attached to the tubular supports 22a, 22b sleeved over the support rods 21a, 21b of an optional stand. However, rather than the tension spring 30 employed in the embodiment of the training device 10 shown in FIG. 1, the embodiment of the training device 50 shown in FIG. 7 is provided with a number of elastic bands 52a-52d attached between the immovable components of the training device (e.g., the support member 22 and the simulated scapula 18) and the moveable humerus bone 14 including its humeral head 14a which is operatively associated with the dislocation guide 54. The tension force, number and/or location of elastic bands 52a-52d can be selected by those skilled in this art to provide biofidelic forces during the reduction training exercise using the training device 50.

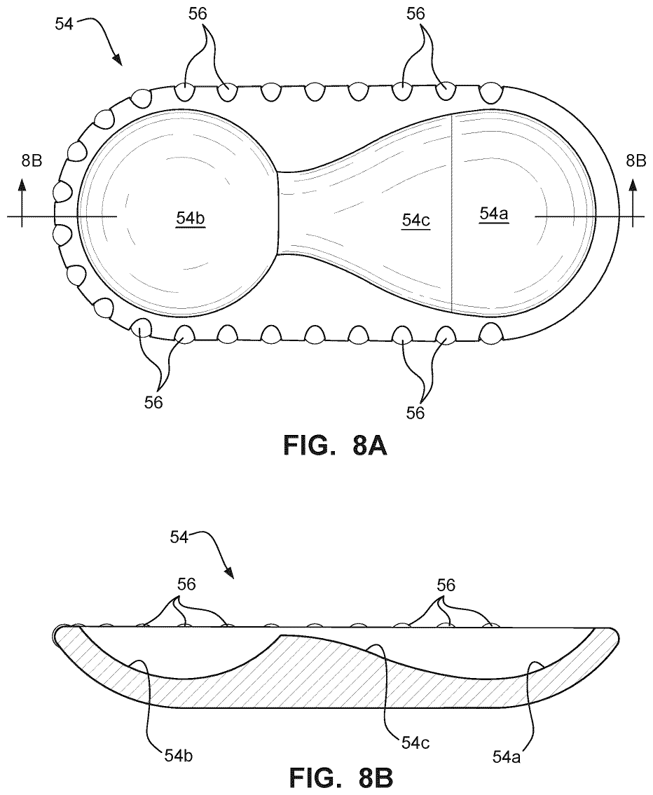

The dislocation guide 54 employed in the embodiment of shoulder joint training device 50 is shown in greater detail in FIGS. 8A and 8B. As shown, the dislocation guide 54 is similar to the dislocation guide 16 discussed previously in that it includes a dislocated position socket 54a, a reduced position socket 54b and a transition surface 54c joining the sockets 54a, 54b. In the embodiment shown, there is no angular displacement between the dislocated and position sockets 54a, 54b, respectively, so as to provide different practice difficulties during a reduction training exercise. Instead, the slope of the transition surface 54c may be increased or decreased from one dislocation guide 54 to another so as to increase or decrease the difficulty of the reduction training exercise. In order to reduce friction and to minimize chafing between the elastic bands 52a-52d, a series of bearings (a representative few of which are identified by reference 56 in FIGS. 7 and 8A-8B) may be embedded in the edge of the dislocation guide.

The embodiments of the dislocation guides described above will function so as to allow the synthetic joints to move between the dislocated and reduced positions. The tension elements allow the training device to be in equilibrium in both positions in order to provide a steady state and enable a realistic and stable transition from the dislocated position to the reduced position, thereby mimicking the role of soft tissue in the respective joints. As noted above, one dislocation guide can be removed and replaced with a dislocation guide of different geometry in order to represent different dislocations (e.g., anterior and posterior shoulder dislocations).

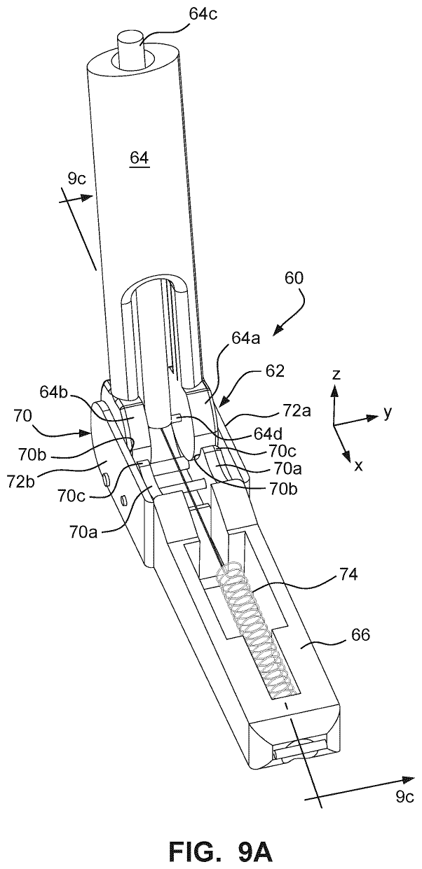

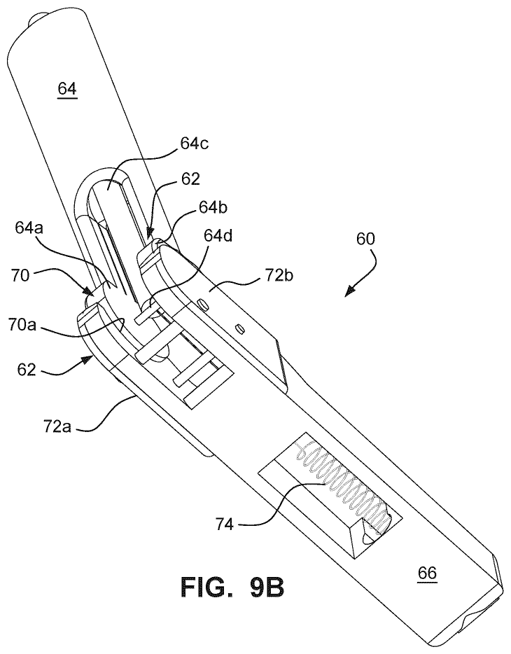

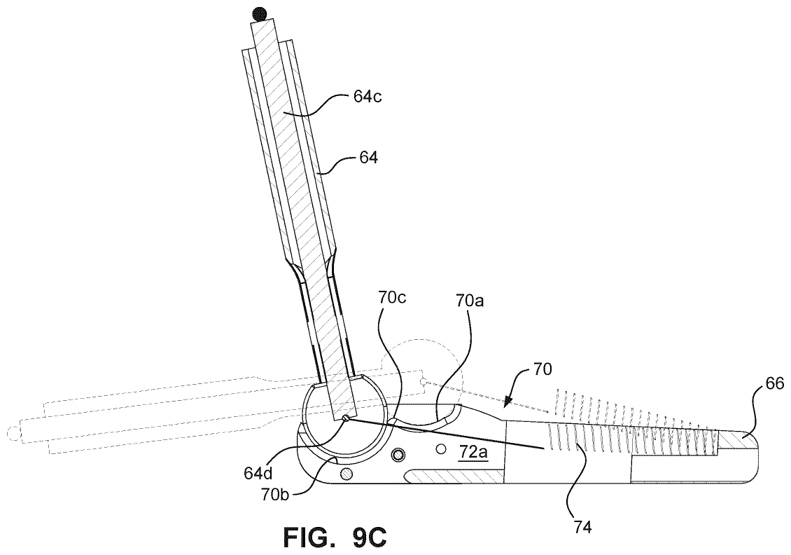

Accompanying FIGS. 9A-9C show an embodiment of an elbow joint dislocation training device 60 in accordance with the invention described herein which simulates an elbow joint 62, e.g., a simulated humeroradial joint or a humeroulner joint formed between the distal end of a proximally located humerus bone of the upper arm and the distally located radium or ulna bones of the forearm. The training device 60 shown in FIGS. 9A-9C will thus include a proximal simulated arm bone component 64 (e.g., simulating the proximally located humerus bone of the upper arm) and a distal simulated arm bone component 66 (e.g., simulating the distally located radium or ulna bones of the forearm).

The distal terminal end of the proximal simulated arm bone component 64 is preferably a tubular structure which terminates in a forked pair of curved parallel joint heads 64a, 64b. A support rod 64c may extend through the tubular proximal simulated arm bone component 64 so as to connect to an external stand, e.g., the stand structure 20 discussed previously in connection to FIG. 1. The lower (distal) end of the support rod is connected to a cross-support rod 64d extending between the laterally separated joint heads 64a, 64b so as to provide a stable structural unit.

The distal simulated arm bone component 66 includes a dislocation guide 70 at a terminal end thereof in operative association with the joint heads 64a, 64b. The dislocation guide 70 includes an arcuately curved dislocation socket 70a which establishes the dislocation position of the proximal simulated arm bone component 64 relative to the distal simulated arm bone component 66, and a reduction socket 70b which establishes the reduced position of the proximal simulated arm bone component 64 relative to the distal simulated arm bone component 66. A transition surface 70c joins the dislocated and reduced position sockets 70a, 70b, respectively. Each of the joint heads 64a, 64b is therefore engageable with respective ones of the sockets 70a, 70b. A set of retainer plates 72a, 72b restrain the lateral movements (e.g., along the y-axis) of the proximal simulated arm bone component 64 relative to the distal simulated arm bone component 66.

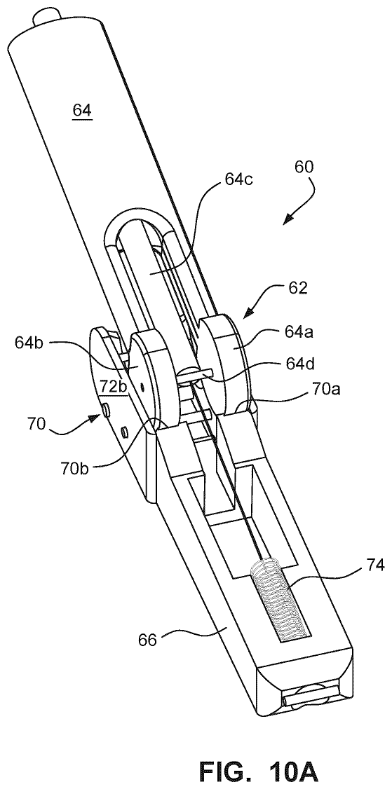

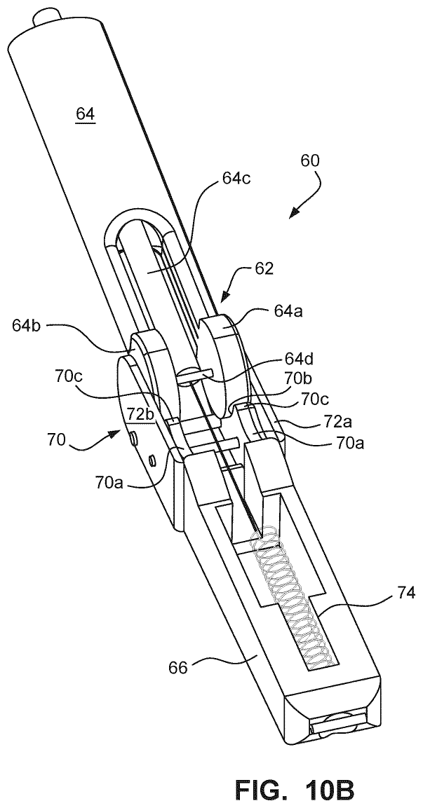

A fixed-position tension spring 74 extends between an end of the distal simulated arm bone component 66 and the support rod 64c of the proximal simulated arm bone component 64 so as to provide biofidelic motion to the simulated bone components 64, 66 during a reduction training exercise. Specifically, the spring element 74 allows the proximal simulated arm bone component 64 to be rotated about the y-axis as well as being linearly moved along the x-axis and/or y-axis during a reduction training exercise to allow the joint heads 64a, 64b of the proximal simulated arm bone component 64 to be moved over the transition surfaces 70c of the dislocation guide and thereby translated from the dislocated position sockets 70a (i.e., as shown in dashed lines of FIG. 9C and depicted also in FIG. 10A) to the reduced position sockets 70b, respectively (i.e., as represented by the solid lines of FIG. 9C and depicted also in FIG. 10B). Additional tension bands (not shown) may be attached between the proximal simulated arm bone components 64 relative to the distal simulated arm bone component 66 to enhance the biofidelic motion of the elbow joint 60 during a reduction training exercise.

The position and dynamic force sensors 40/42 and 46, respectively, that were discussed above in relation to the shoulder joint training device 10 shown in FIG. 1 may also be integrated elbow joint dislocation training device 60 of FIGS. 9A-9C and 10A-10B.

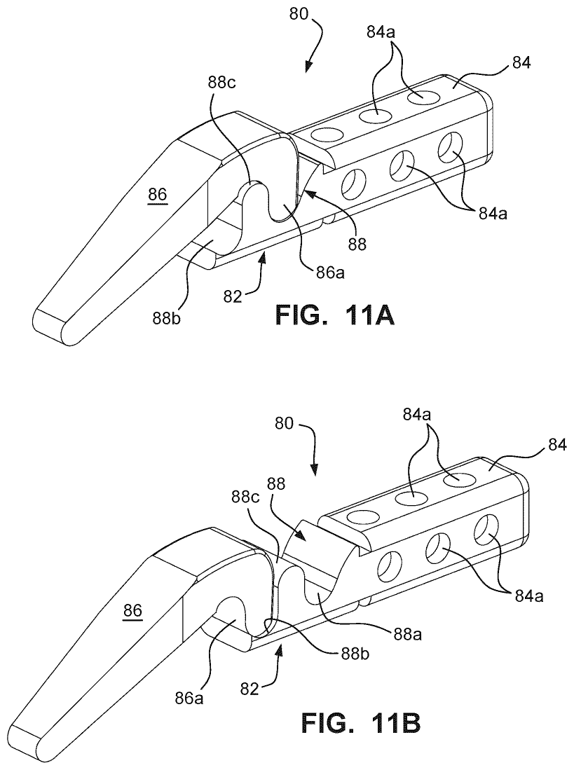

A finger joint training device 80 having a simulated finger joint 82 providing a simulation between proximal and distally positioned simulated phalanx bone components 84, 86 is shown in FIGS. 11A and 11B. The distal end of the proximally positioned simulated phalanx bone component 84 includes dislocation guide 88. The dislocation guide 88 includes an arcuately curved dislocation socket 88a which establishes the dislocation position of the proximally positioned simulated phalanx bone component 84 relative to the distally positioned simulated phalanx bone component 86, and a reduction socket 88b which establishes the reduced position of the proximally positioned simulated phalanx bone component 84 relative to the distally positioned simulated phalanx bone component 86. A transition surface 88c joins the dislocated and reduced position sockets 88a, 88b, respectively.

The proximal end of the distally positioned simulated phalanx bone 86 includes a protuberance 86a having an arcuately curved terminal end that may cooperatively be engaged with yet move between the dislocated position socket 88a (as show in FIG. 11A) and the reduced position sockets 88b (as shown in FIG. 11B) during a reduction training exercise. During such movement between the dislocated and reduced position sockets 88a, 88b, respectively, the curved terminal end of the protuberance 86a will traverse the transition surface 86c therebetween.

Although not shown in FIGS. 11A and 11B, the finger joint training device 80 may be provided with anterior, posterior and lateral tension elements (e.g., elastic bands) extending between and connected to each of the proximal and distally positioned simulated phalanx bone components 84, 86, respectively, so as to impart biofidelic motion to the simulated phalanx bone components 84, 86 during a reduction training exercise. The proximal positioned simulated phalanx bone component 84 may include a series of through apertures 84a to allow connection of the tension elements and/or to allow connection of the training device 80 to a support structure, e.g., the stand structure 20 discussed previously in connection to FIG. 1.

The position and dynamic force sensors 40/42 and 46, respectively, that were discussed above in relation to the shoulder joint training device 10 shown in FIG. 1 may also be integrated with the finger joint dislocation training device 80 of FIGS. 11A and 11B.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope thereof.

What is claimed is:

1. A joint reduction simulation training device comprising:
a proximal bone component, and
a distal bone component adjacently positioned relative to the proximal bone component, wherein
the proximal bone component includes a dislocation guide operatively cooperating with an opposed terminal end of the distal simulated bone component to provide a simulated joint between the proximal and distal bone components, and wherein
the dislocation guide includes:
(i) a dislocation socket establishing a dislocated position of the distal simulated bone component relative to the proximal bone component when the terminal end of the distal simulated bone component is physically positioned within the dislocation socket,
(ii) a reduction socket establishing a reduced position of the distal simulated bone component relative to the proximal bone component when the terminal end of the distal simulated bone component is physically positioned within the reduction socket, and
(iii) a transition surface joining the dislocation and reduction sockets, the terminal end of the distal simulated bone component being in traversing engagement with the transition surface when the terminal end of the distal simulated bone component is moved from the dislocation socket and into the reduction socket during a reduction training exercise.

2. The training device according to claim 1, wherein the dislocation and reduction sockets are angularly oriented relative to one another at an angle α that is greater than about 45° and less than 180°.

3. The training device according to claim 1, further comprising at least one tension element exerting a biofidelic tension force between the proximal and distal bone components.

4. The training device according to claim 3, wherein the at least one tension element includes a tension spring or an elastic band.

5. The training device according to claim 1, wherein the distal simulated bone component is a simulated humerus bone having a simulated humeral head operatively engaged with the dislocation guide so as to establish a simulated shoulder joint.

6. The training device according to claim 5, further comprising at least one tension element exerting a biofidelic tension force between the proximal and distal bone components.

7. The training device according to claim 6, wherein the at least one tension element includes a tension spring or an elastic band.

8. The training device according to claim 6, wherein the dislocation guide includes an elongated channel extending between the dislocation and reduction sockets, and wherein the at least one tension element comprises a tension spring extending through the channel so as to connect the proximal simulated bone component to the simulated humeral head.

9. The training device according to claim 5, further comprising a foam material covering the simulated humerus bone to simulate soft tissue and skin of a patient arm.

10. The training device according to claim 1, further comprising a stand structure connected to the proximal simulated bone component to position the training device in an upright state.

11. The training device according to claim 1, wherein the dislocation guide comprises a plurality of bearings positioned along at least a portion of an edge thereof.

12. The training device according to claim 1, wherein the proximal simulated one component comprises a forked pair of curved parallel joint heads each operatively cooperating with the dislocation and reduction sockets and the transition surface therebetween.

13. The training device according to claim 12, wherein the terminal end of the distal simulated bone component includes the dislocation guide, and wherein the dislocation guide includes a set of retainer plates laterally adjacent to the dislocation and reduction sockets to restrain lateral movements of the proximal simulated bone component relative to the distal simulated bone component.

14. The training device according to claim 13, further comprising a tension element interconnecting the distal and proximal simulated bone components.

15. The training device according to claim 1, wherein the distal simulated bone component comprises a protuberance having an arcuately curved terminal end for cooperative engagement with the dislocation and reduction sockets.

16. The training device according to claim 1, wherein further comprising a position sensor system for sensing a position of the terminal end of the distal bone component within the reduction socket.

17. The training device according to claim 16, wherein the sensing system comprises:
a normally open magnetically operable reed switch operatively associated with the reduction socket of the dislocation guide;
at least one permanent magnet provided at the terminal end of the distal simulated bone component which defines a correct reduction of the terminal end of the simulated bone component in the reduction socket; and
an annunciator receiving an annunciation signal from the reed switch in response to the reed switch being operated by the at least one permanent magnet being in operative position relative thereto.

18. The training device according to claim 1, further comprising a dynamic force sensor array comprising at least one dynamic force sensor selected from the group consisting of accelerometers, magnetometers, gyroscopes and force/strain sensors operatively connected to the distal simulated bone component to provide quantitative data associated with joint reduction dynamics of the training device.

19. The training device according to claim 18, wherein the sensor array comprises:
an inertial measurement unit (IMU) integrated onto the distal simulated bone component which includes a 3-axis accelerometer, 3-axis gyroscope and 3-axis magnetometer to generate respective inertial data signals in response to movement of the distal simulated bone component; and
a wireless transmitter module operatively connected to the IMU to receive the inertial data signals generated by the IMU and to transmit the inertial data signals wirelessly to a receiving computing device.

20. A joint reduction training method comprising the steps of:
(a) providing the joint reduction simulation device according to claim 1 such that the terminal end of the distal simulation bone component is positioned within the reduction socket of the dislocation guide; and
(b) forcibly manipulating the distal simulation bone component relative to the proximal bone component so as to move the distal end of the distal simulation bone component from the dislocation socket and into the reduction socket.
